(19) United States
(12) Patent Application Publication
(10) Pub. No.: US 2015/0377186 A1
(43) Pub. Date: Dec. 31, 2015

(54) SYSTEM FOR THE RECIRCULATION OF EXHAUST GASES

(71) Applicant: Valeo Systemes Thermiques, Le Mesnil Saint Denis (FR)

(72) Inventors: Jérôme Blanchard, Bleury (FR); Benjamin Ferlay, Cernay La Ville (FR); Julio Guerra, Itteville (FR)

(73) Assignee: VALEO SYSTEMES THERMIQUES, Le Mesnil Saint Denis (FR)

(21) Appl. No.: 14/748,630

(22) Filed: Jun. 24, 2015

(30) Foreign Application Priority Data
Jun. 25, 2014 (FR) 1455880

(51) Int. Cl. F02M 25/07; F02B 29/04; F02M 35/10

(52) U.S. Cl. CPC F02M 25/0714; F02M 25/072; F02M 25/0748; F02M 35/10321; F02M 35/10157; F02B 29/0406; F02M 35/10006

(57) ABSTRACT

A system for the recirculation of exhaust gases is disclosed. The system includes an air intake device for an internal combustion engine with intake ducts feeding air to the combustion cylinders, each combustion cylinder including an intake duct of its own, and the intake ducts include an exhaust gas inlet orifice for exhaust gases. The system also includes a recirculation circuit for the exhaust gases, an injection rail including outlet orifices for the exhaust gases connected to the inlet orifices of the intake ducts, the connection between the inlet orifices and the outlet orifices being produced by a tapered coupling element. The tapered coupling element includes a connection tube connected to the outlet orifice of the injection rail and descending within the inlet orifice to guide the exhaust gases emerging from the injection rail within the intake duct.

The invention relates to the field of motor vehicles and more specifically to systems for the recirculation of exhaust gases.

In order to reduce polluting emissions, in particular in the form of oxides of nitrogen, it is customary to reinject a proportion of the exhaust gases into the inlet for intake air by means of a system for the recirculation of the exhaust gases. The injection of these exhaust gases that are recirculated in the intake air may be achieved by means of an injection rail, perpendicular to the flow of intake air, provided with orifices permitting the intake of recirculated exhaust gases in the area of each combustion cylinder. The quantity of recirculated exhaust gases arriving in the intake air of the combustion cylinders is controlled by a specific valve, referred to as an EGR valve, positioned upstream of the injection rail. It is in effect necessary to control the quantity of recirculated exhaust gases arriving in each combustion cylinder accurately in order to respect the balance between the emissions of oxides of nitrogen and particles emerging from this recirculation.

However, the exhaust gases arriving in the area of the injection rail and in the inlet for intake air are at a high temperature, which requires these elements to be made from an expensive material that is resistant to high temperatures.

One of the aims of the present invention is thus to address the disadvantages of the prior art and to propose a cost-effective system for the recirculation of exhaust gases.

The present invention thus relates to a system for the recirculation of exhaust gases including:

an air intake device for an internal combustion engine comprising intake ducts feeding air to the combustion cylinders, each combustion cylinder including an intake duct of its own, said intake ducts including an inlet orifice for exhaust gases, and

a recirculation circuit for the exhaust gases comprising an injection rail including outlet orifices for the exhaust gases connected to the inlet orifices of the intake ducts,

the connection between the inlet orifices and the outlet orifices being produced by a tapered coupling element, said tapered coupling element including:

a connection tube connected to the outlet orifice of the injection rail and descending within the inlet orifice in such a way as to guide the exhaust gases emerging from the injection rail within the intake duct, said connection tube having a diameter smaller than the diameter of the inlet orifice,

a tapered connector including a top attached to the connection tube and a bottom attached to the periphery of the inlet orifice.

The presence of this tapered coupling element enables thermal decoupling to be obtained between, on the one hand, the injection rail and the tapered coupling element which are traversed and heated by the exhaust gases having the ability to reach a temperature in the order of 450° C., and, on the other hand, the interface between the tapered coupling element and the periphery of the inlet orifice. The temperature which may be reached by the interface between the tapered coupling element and the periphery of the inlet orifice may thus be in the order of 175° C. or below, which justifies the manufacture of the intake ducts and, more generally, of the air intake device in a material that is less resistant to heat and, as such, is less costly to produce.

According to one aspect of the invention, a seal is positioned between the bottom of the tapered connector and the periphery of the inlet orifice.

According to another aspect of the invention, the top of the tapered connector faces toward the interior of the intake duct.

According to another aspect of the invention, the top of the tapered connector faces toward the exterior of the intake duct.

According to another aspect of the invention, the attachment between the bottom of the tapered connector and the air intake device is produced by means of at least one attachment screw.

According to another aspect of the invention, the injection rail and the tapered coupling element are metallic.

According to another aspect of the invention, the air intake device is made from a plastic material.

According to another aspect of the invention, the internal combustion engine is a supercharged engine and the air intake device includes a charge air cooler positioned upstream of the connection of said air intake device to the injection rail.

Other characterizing features and advantages of the invention will be appreciated more clearly from a perusal of the following description, given by way of illustrative and non-exhaustive example, and from the accompanying drawings, in which:

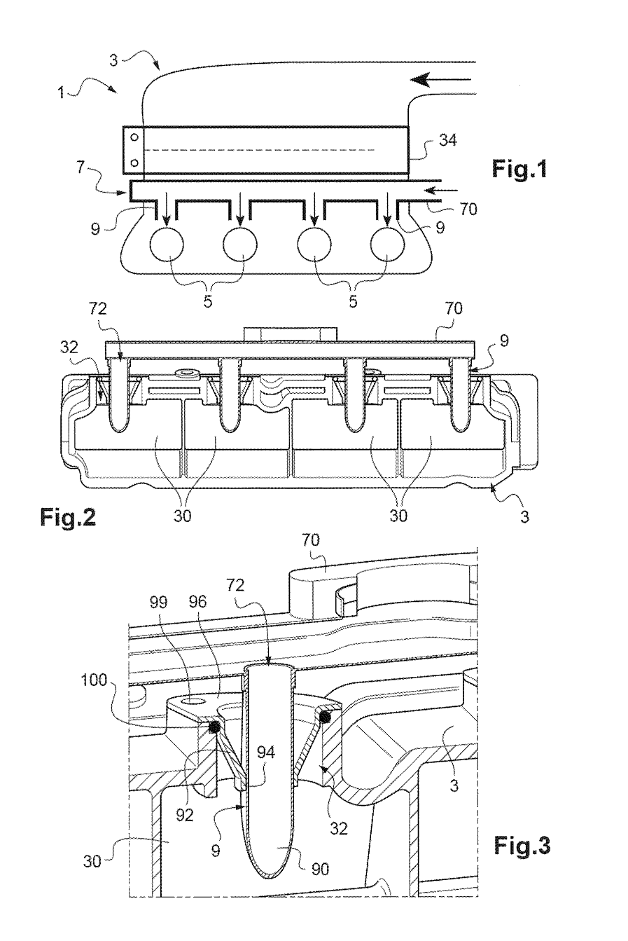

FIG. 1 shows a schematic representation in a view from above of a system for the recirculation of exhaust gases,

FIG. 2 shows a schematic cross-sectional representation of a system for the recirculation of exhaust gases,

FIG. 3 shows a schematic perspective and cross-sectional representation of the connection between an injection rail and an intake duct.

In the different figures, identical elements bear the same reference numbers.

FIG. 1 shows a schematic representation of a system for the recirculation of exhaust gases 1. The latter includes an air intake device 3 for an internal combustion engine as well as a recirculation circuit 7 for the exhaust gases.

The air intake device 3 comprises in particular intake ducts 30 (visible in FIGS. 2 and 3) feeding air to the combustion cylinders 5. Each combustion cylinder 5 includes an intake duct 30 of its own. As shown in FIGS. 2 and 3, said intake ducts 30 include an inlet orifice 32 for exhaust gases permitting the connection with the recirculation circuit 7 for the exhaust gases.

The internal combustion engine may in particular be a supercharged internal combustion engine. The air inlet device 3 may thus include a charge air cooler 34, as shown in FIG. 1. The connection between the intake ducts 30 and the distribution rail 70 is then produced downstream of the charge air cooler 34.

The recirculation circuit 7 for the exhaust gases comprises, for its part, an injection rail 70 extending perpendicularly in the direction of circulation of the intake air and positioned above the intake ducts 30. The injection rail 70 includes outlet orifices 72 connected to the inlet orifices 32 of the intake ducts 30, through which the exhaust gases pass in order to reach the intake ducts 30.

The connection between the inlet orifices 32 and the outlet orifices 72 is produced by a tapered coupling element 9 as illustrated in FIGS. 2 and 3. This tapered coupling element 9 includes in particular a connection tube 90 connected to the outlet orifice 72 of the injection rail 70 and descending within the inlet orifice 32 in such a way as to guide the exhaust gases emerging from the injection rail 70 within the intake duct 30. The connection tube 90 has a diameter smaller than the diameter of the inlet orifice 32 in order for it to be inserted there without coming into contact with the walls of said inlet orifice 32.

The tapered coupling element 9 includes in addition a tapered connector 92 providing the connection between the connection tube 9 and the inlet orifice 32. The tapered connector 92 includes a top 94 attached in a sealed manner to the connection tube 90 and a bottom 96 attached, likewise in a sealed manner, to the periphery of the inlet orifice 32.

The presence of this tapered coupling element 9 enables thermal decoupling to be obtained between, on the one hand, the injection rail 70 and the tapered coupling element 9 which are traversed and heated by the exhaust gases having the ability to reach a temperature in the order of 450° C., and, on the other hand, the interface between the tapered coupling element 9 and the periphery of the inlet orifice 32. The temperature which may be reached by the interface between the tapered coupling element 9 and the periphery of the inlet orifice 32 may thus be in the order of 175° C. or below, which justifies the manufacture of the intake ducts and, more generally, of the air intake device 3 from a material that is less resistant to heat and, as such, is less costly to produce.

The air intake device 3 may be made from a plastic material, for example a polyamide reinforced with glass fibers such as PA66-GF50.

The tapered coupling element 9, for its part, may be metallic in order to withstand the temperatures of the exhaust gases. The attachment between the tapered connector 92 and the connection tube 90 may thus be produced by welding or brazing, as may the connection between the connection tube 90 and the injection rail 70 in the area of the inlet orifice 72.

In order to improve the sealing in the area of the inlet orifice 32, a seal 100 may be positioned between the bottom 96 of the tapered connector 92 and the periphery of the inlet orifice 32.

The attachment of the tapered coupling element 9 to the inlet device 3 may be produced, as illustrated in FIG. 3, by at least one screw (not depicted here) fitting in a hole 99 passing through the bottom 96 of the tapered connector 92. Said screw is screwed into an orifice that is tapped into the inlet device 3.

As illustrated in FIGS. 2 and 3, the tapered connector 92 may have its top 94 facing toward the interior of the intake duct 30. It is entirely possible, however, to imagine an embodiment in which the top 94 of the tapered connector 92 faces toward the exterior of the intake duct 30.

It can thus be readily appreciated that, thanks to the presence of the tapered coupling element 9 which permits the realization of a thermal decoupling between the injection rail 70 and the inlet device 3, it is possible to manufacture the latter from a material that is less resistant to heat and less costly, for example from a plastic material.

1. A system for the recirculation of exhaust gases comprising:
an air intake device for an internal combustion engine comprising intake ducts feeding air to the combustion cylinders, each combustion cylinder including an intake duct of its own, said intake ducts including an inlet orifice for exhaust gases; and
a recirculation circuit for the exhaust gases comprising an injection rail including outlet orifices for the exhaust gases connected to the inlet orifices of the intake ducts, wherein
the connection between the inlet orifices and the outlet orifices is produced by a tapered coupling element, said tapered coupling element including:
a connection tube connected to the outlet orifice of the injection rail and descending within the inlet orifice in such a way as to guide the exhaust gases emerging from the injection rail within the intake duct, said connection tube having a diameter smaller than the diameter of the inlet orifice, and
a tapered connector including a top attached to the connection tube and a bottom attached to the periphery of the inlet orifice.

2. The system for the recirculation of exhaust gases according to claim 1, wherein a seal is positioned between the bottom of the tapered connector and the periphery of the inlet orifice.

3. The system for the recirculation of exhaust gases according to claim 1, wherein the top of the tapered connector faces toward the interior of the intake duct.

4. The system for the recirculation of exhaust gases according to claim 1, wherein the top of the tapered connector faces toward the exterior of the intake duct.

5. The system for the recirculation of exhaust gases according to claim 1, wherein the attachment between the bottom of the tapered connector and the air intake device is produced by means of at least one attachment screw.

6. The system for the recirculation of exhaust gases according to claim 1, wherein the injection rail and the tapered coupling element are metallic.

7. The system for the recirculation of exhaust gases according to claim 1, wherein the air intake device is made from a plastic material.

8. The system for the recirculation of exhaust gases according to claim 1, wherein the internal combustion engine is a supercharged engine, and in that the air intake device includes a charge air cooler positioned upstream of the connection of said air intake device to the injection rail.
